(19) United States
(12) Patent Application Publication
(10) Pub. No.: US 2026/0321253 A1
(43) Pub. Date: Oct. 15, 2026

(54) Application Mapping AI Module for Autonomous Control of Third-Party Applications Without APIs

(71) Applicant: Liguo Zhao, HOLLAND, OH (US)

(72) Inventor: Liguo Zhao, HOLLAND, OH (US)

(21) Appl. No.: 19/175,384

(22) Filed: Apr. 10, 2025

(51) Int. Cl. G10L 15/22; G06F 3/01; G06F 21/71; G10L 15/18

(52) U.S. Cl. CPC G10L 15/22; G06F 3/017; G06F 21/71; G10L 15/1807; G10L 15/1815; G10L 2015/223

(57) ABSTRACT

Disclosed is a system that enables AI agents to autonomously control third-party applications without requiring explicit API access. The Application Mapping AI Module interprets user intent expressed in natural language and maps it to control sequences that operate user interface components. It employs a hybrid method using accessibility trees and visual recognition (e.g., screen capture and OCR), combined with a semantic mapping engine that links commands to UI actions. The system dynamically identifies interactive elements, infers their function, and generates execution paths. It adapts to UI layout changes through machine learning and includes state monitoring and fallback strategies to ensure task completion despite interface inconsistencies. This invention allows AI assistants to perform multi-step operations in applications lacking traditional programmatic interfaces. All sensitive user data is processed locally to ensure privacy.

This Substitute Specification is submitted in response to the Office's Notice of Incomplete Reply (Nonprovisional). This Substitute Specification replaces the specification previously filed in this application. No new matter is introduced.

### FIELD OF THE INVENTION

The present invention relates generally to the field of artificial intelligence and user interface automation. More particularly, it pertains to systems and methods for autonomous semantic understanding and control of graphical user interfaces (GUIs) using non-API-based techniques.

### BACKGROUND OF THE INVENTION

Existing accessibility systems, such as those described in US20040064593A1, focus on exposing user interface structures through filtered logical trees to assist client applications in querying UI information. However, these systems do not autonomously execute control sequences based on natural language intent or manage multi-step task execution.

Similarly, vision-based interaction systems (e.g., US20110134124A1) rely on gaze tracking or image recognition alone for input simulation. These systems lack semantic reasoning, interface adaptation, and control verification.

Emerging research in semantic UI understanding (e.g., UiPath, IBM) improves how automation tools recognize and group UI elements, but still typically assumes prior knowledge of the app or pre-integration.

The present invention fills these gaps by introducing a novel AI-driven control module that understands user intent, analyzes UI structure, applies fallback visual methods, and generates interaction paths—all without requiring API-level access or pre-trained knowledge of the application. It enables secure, cross-application task automation even in unknown environments.

### DETAILED TECHNICAL IMPLEMENTATION

The present invention introduces the Application Mapping AI Module, a system that enables artificial intelligence agents to autonomously operate third-party applications based on natural language commands, even when such applications offer no programmatic API access. The module applies a hybrid control strategy, combining structured interface analysis (e.g., accessibility trees) and unstructured visual recognition (e.g., screen OCR or icon classification), to locate and interact with interface elements. The following sections describe each component of the system in detail.

A key component of the invention is a semantic mapping engine, which interprets user intent and maps it to specific UI control sequences. The system is capable of adapting to changing application interfaces over time through continual learning of layout patterns. It further includes a state monitoring engine that confirms execution success, and a privacy safeguard layer that ensures sensitive user data is processed locally. When interface control fails, the system applies retry logic or reroutes execution through fallback methods. This enables cross-application automation, secure task fulfillment, and generalizable UI control without prior integration.

The Application Mapping AI Module employs several advanced techniques to achieve robust control of third-party applications without API access. These techniques include semantic intent interpretation, accessibility-based UI analysis, visual fallback recognition, semantic mapping with contextual reasoning, adaptive execution planning, real-time state monitoring, reinforcement-based learning, user demonstration learning, and privacy-preserving local processing, all of which are described in detail below.

### Semantic Intent Interpretation

The module uses a natural language understanding (NLU) model fine-tuned on application control tasks to parse user commands into structured intent representations. This model employs transformer-based architecture with attention mechanisms to capture the nuances of user requests. The intent representation includes the primary action (e.g., ‘login’, ‘search’, ‘book’), target objects (e.g., ‘account’, ‘flights’), and relevant parameters (e.g., dates, quantities, preferences).

### UI Structure Analysis

The structure analyzer leverages platform-specific accessibility frameworks (such as Android Accessibility Services, iOS UIAccessibility, or Windows UI Automation) to construct a hierarchical representation of the application's interface. This representation includes element types, properties, containment relationships, and available actions. The analyzer prioritizes elements that are likely to be interactive based on their properties and context.

### Visual Recognition Fallback

When accessibility data is insufficient or unavailable, the visual fallback system activates. This system captures the screen and employs a multi-stage computer vision pipeline: (1) a segmentation model identifies potential UI elements; (2) an OCR engine extracts text content; (3) a classification model categorizes elements by type (button, field, toggle, etc.); and (4) a context analysis model determines the likely function of each element based on its appearance and surrounding elements.

### Semantic Mapping Engine

The core innovation of the system is the semantic mapping engine that bridges natural language intent to UI actions. This engine employs a combination of techniques:
A knowledge graph representing common UI patterns and their relationship to user intents
A neural matching model that scores potential UI elements against the current intent
A contextual reasoning component that considers application state and task progress
A reinforcement learning model that improves mapping accuracy based on success/failure feedback

The semantic mapper is pre-trained on a diverse corpus of application interactions and continues to learn from successful executions, allowing it to generalize to previously unseen applications and interfaces.

### Execution Planning and Control

The execution planner converts the semantic mapping into a concrete sequence of UI operations. It employs a graph-based planning algorithm that considers dependencies between actions and optimizes for efficiency and robustness. The planner includes contingency handling for common failure cases and can dynamically adjust the plan based on unexpected application responses.

The control execution module implements the plan through platform-specific mechanisms, prioritizing accessibility API calls when available and falling back to simulated input when necessary. It simulates user actions either by invoking system-level accessibility actions such as ACTION_CLICK, ACTION_SET_TEXT, or by generating gesture inputs through platform-supported input APIs. This allows the system to perform interactions equivalent to a human user tapping, typing, or swiping on the screen, without requiring physical input or app-level integration. All operations include verification steps to confirm successful execution.

### State Monitoring and Verification

The state monitoring system continuously tracks the application's response to actions using both structural and visual analysis. It compares the actual state against expected outcomes defined in the execution plan. This comparison uses a similarity metric that tolerates minor UI variations while detecting significant deviations that indicate success or failure.

### Adaptive Learning

The system employs reinforcement learning techniques to continuously improve its performance. Successful interaction patterns are reinforced, while failed approaches are penalized. The learning system maintains application-specific models that capture the unique characteristics of each application's interface and behavior patterns. These models are updated incrementally as the system interacts with applications, allowing it to adapt to interface changes without requiring complete retraining.

In addition to reinforcement-based adaptation, the system may optionally observe manual user interactions with third-party applications. With appropriate user consent or configuration, these manually performed action sequences can be recorded and converted into generalized semantic control templates. These learned templates enable the system to automate similar future tasks more efficiently and reliably, especially in applications it has not previously encountered. This demonstration-based learning complements the reinforcement learning process and accelerates control graph acquisition

### Privacy and Security

All processing of sensitive information occurs locally on the user's device. The system includes mechanisms to identify fields containing credentials or personal information and ensures this data is never transmitted off-device. The module also respects application security boundaries and does not attempt to circumvent legitimate security measures.

The system may further determine the visibility context dynamically based on the nature of the task. For example, scheduled tasks such as daily news briefing may execute in an invisible display buffer mode, whereas user-initiated voice commands will invoke a visible execution path to enable real-time feedback and interaction.

### BRIEF DESCRIPTION OF THE DRAWINGS

FIG. 1 illustrates the architecture of the Application Mapping AI Module, showing the flow from natural language input through intent parsing, UI analysis, semantic mapping, and execution.

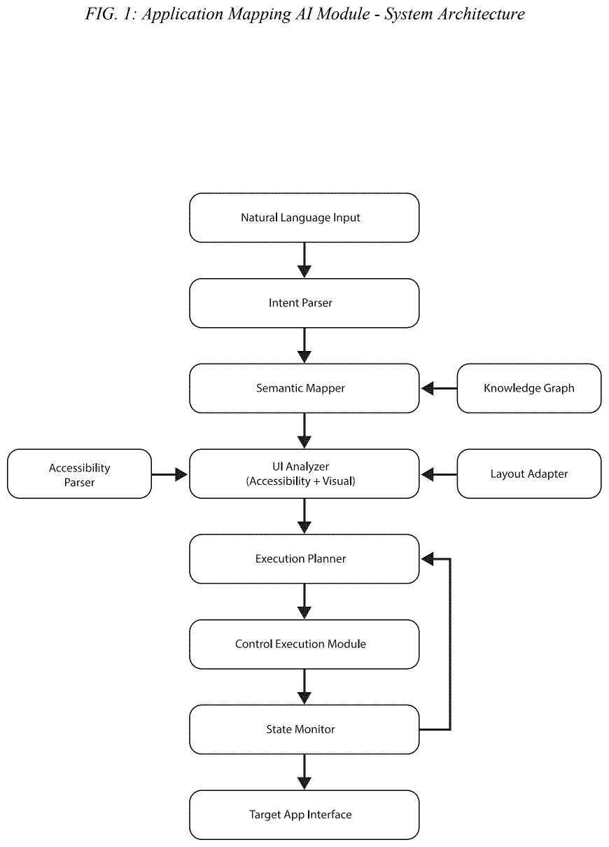

FIG. 2 presents a flowchart of the execution process, including the decision points for accessibility data sufficiency and task completion verification.

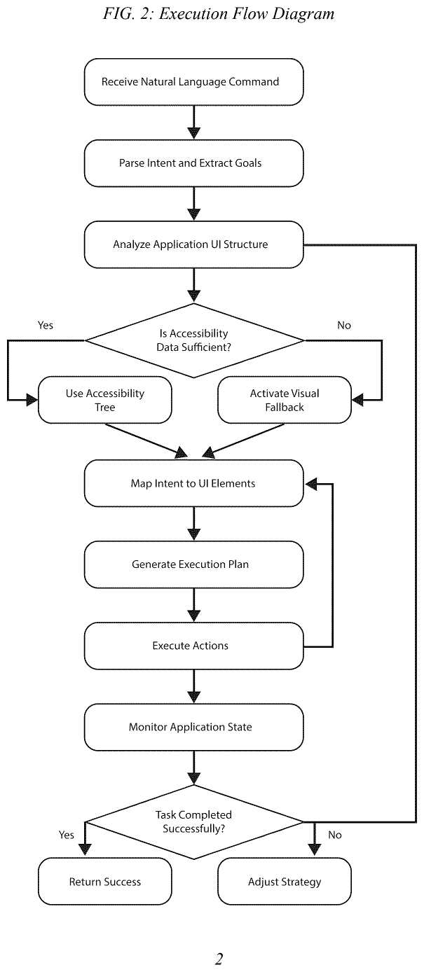

FIG. 3 depicts the semantic mapping process, showing how natural language commands are transformed into specific UI actions through intent extraction, element discovery, and semantic matching.

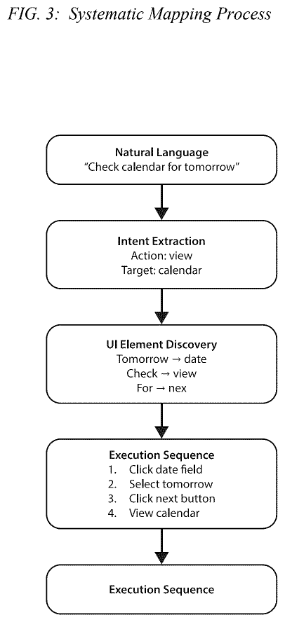

23. A system for voice-driven control of third-party applications without APIs, comprising:
(a) a speech recognition module configured to convert raw audio input into text commands;
(b) the intent recognition engine of claim 1(a), further configured to parse said text commands into structured intent representations;
(c) a prosody analysis component configured to infer urgency or context from vocal tone, pitch, or pauses in the raw audio input; and
(d) the semantic mapping engine of claim 1(d), configured to prioritize UI actions based on inferred urgency.

24. The system of claim 23, wherein the speech recognition module processes audio input locally on the user's device using a lightweight acoustic model, such that no voice data is transmitted to external servers.

25. The system of claim 23, further comprising a voice interruption handler configured to dynamically adjust or halt the execution plan in response to real-time voice commands including, but not limited to, ‘stop,’ ‘pause,’ or ‘cancel.’

26. A system for multimodal control of third-party applications, comprising:
(a) the intent recognition engine of claim 1(a), configured to receive and interpret user input from one or more sources including voice, text, and physical gesture;
(b) a fusion engine configured to resolve conflicts or ambiguity between input modalities using contextual reasoning and task state awareness; and
(c) the semantic mapping engine of claim 1(d), configured to generate application control sequences based on combined multimodal input signals.

27. The system of claim 26, wherein physical gestures are captured via sensors including, but not limited to, depth-sensing cameras or motion detectors, and interpreted by a machine learning model including, but not limited to, a convolutional neural network trained on gesture-to-UI-action datasets, to infer user intent.

28. A system for predictive UI automation, comprising:
(a) a historical interaction database configured to store structured records of user intent, corresponding UI actions, and application responses;
(b) a machine learning model trained on said database to identify and predict probable UI workflows in advance of explicit user input; and
(c) the execution planner of claim 1(e), further configured to preload said predicted workflows and present them for user confirmation or override prior to execution.

29. The system of claim 28, wherein the machine learning model employs a transformer-based architecture trained to anticipate multi-step application tasks based on partial or incomplete natural language commands.

30. A system for secure credential handling in UI automation, comprising:
(a) a credential detection module configured to identify password fields or authentication prompts through visual analysis and accessibility structure parsing;
(b) a secure enclave subsystem configured to store and manage encryption keys and user credentials in isolation from the main automation runtime; and
(c) the control execution module of claim 1(e), further configured to inject credentials into identified input fields by simulating keystrokes through an obfuscated input channel, such that plaintext credentials are not exposed in memory or logs during execution.

31. A system for cross-platform workflow automation, comprising:
(a) the semantic mapping engine of claim 1(d), configured to interpret user intent and generate UI control actions across multiple applications distributed across separate computing devices;
(b) a synchronization module configured to maintain shared task state and execution context between said devices via encrypted peer-to-peer communication; and
(c) the state monitoring module of claim 1(f), further configured to verify consistent task completion outcomes across all involved devices.

32. The system of claim 31, wherein at least one of the applications resides on an Internet-of-Things (IoT) device, and the control execution module is configured to translate user intent into platform-specific control commands for said IoT device's actuators or sensors.
